(19) United States
(12) Patent Application Publication
(10) Pub. No.: US 2020/0364385 A1
(43) Pub. Date: Nov. 19, 2020

(54) SYSTEM AND METHOD FOR SIMULATING CONTACT BETWEEN WHEEL AND RAIL FOR DETECTING ADHESION VALUES

(71) Applicant: FAIVELEY TRANSPORT ITALIA S.p.A., Piossasco (Torino) (IT)

(72) Inventors: Luc IMBERT, Torino (IT); Matteo FREA, Torino (IT)

(21) Appl. No.: 16/496,029

(22) PCT Filed: Mar. 29, 2018
(86) PCT No.: PCT/IB2018/052170

§ 371 Date: Sep. 20, 2019

(30) Foreign Application Priority Data
Mar. 31, 2017 (IT) 102017000035856

(51) Int. Cl. G06F 30/20; G06F 30/17; G01M 17/08; B60T 8/17

(52) U.S. Cl. CPC G06F 30/20; G06F 30/17; G06F 2119/14; B60T 8/1705; G01M 17/08

(57) ABSTRACT

A system is provided for simulating contact between wheel and rail, in particular of a railway vehicle, comprising at least one hollow cylindrical structure having a first diameter and including a rail simulation surface arranged integrally with an internal surface of the hollow cylindrical structure and at least one wheel having a second diameter smaller than the first diameter and including a rolling surface adapted to be placed in contact with the rail simulation surface of the hollow cylindrical structure.

### CROSS-REFERENCE TO RELATED APPLICATIONS

This application is a National Phase filing of PCT International Application No. PCT/IB2018/052170, having an International Filing Date of Mar. 29, 2018, claiming priority to Italian Patent Application No. 102017000035856, having a filing date of Mar. 31, 2017 each of which is hereby incorporated by reference in its entirety.

### FIELD OF THE INVENTION

The present invention is, in general, in the field of systems and methods for detecting an adhesion value between a wheel of a railway vehicle and a rail; in particular, the invention refers to a system and a method for simulating the contact between wheel and rail for detecting the adhesion value.

### BACKGROUND OF THE INVENTION

The field of methods and systems for analyzing the adhesion value generated by the contact between a wheel of a railway vehicle and a rail is an area wherein important studies are being carried out in search of new solutions.

In the prior art, systems are known for simulating in the laboratory the contact between the wheels of a railway vehicle and the rails.

In such systems, a cylindrical roller is used to simulate a rail for railway vehicles. At least one wheel is placed in sliding contact on the outer perimeter of this roller. The roller is an approximation of the rail, as its cylindrical shape changes the angle of attack between the wheel and the rail.

To reproduce the same conditions of motion of the wheels of a railway vehicle on a track, the angular speed of the wheels and the angular speed of the roller are controlled independently, for example, by using motors.

These systems have also been used to analyze the adhesion between wheel and rail in case of rail contamination. Rail contamination may be due to the presence of water, rotting leaves, oil or other debris.

In known systems, in order to simulate rail contamination, contaminant injection systems are used which inject a contaminant onto the outer perimeter of the roller, near the point of contact with the wheel.

Disadvantageously, as can be seen in FIG. 1, the contaminant substance deposited on the roller by the injection system is flung away by the roller due to centrifugal force, Fcentr, proportional to the square of the angular speed of the roller and the radius of the roller.

This disadvantage does not allow for a stable regulation of the contaminant on the roller surface. As the angular speed of the roller increases, the centrifugal force tends to separate the contaminant from the surface of the roller of interest.

Moreover, this disadvantage introduces a cleaning effect (unrealistic cleaning) between one wheel and the next wheel due to the contaminant being flung away from the roller in the space between one wheel and the next wheel.

Furthermore, the simulation of the presence of the contaminant is limited only to some types of contaminants, to some quantities, or to a limited range of angular speed of the roller.

### SUMMARY OF THE INVENTION

An object of the present invention is therefore to provide a system and a method which allow the condition of contamination of the rail to be simulated by means of a stable contaminant layer for any type of contaminant or any simulated speed.

Furthermore, it is possible to truly evaluate the influence of the contaminant with respect to the adhesion value between the wheel and the rail, and also to take into consideration, during the evaluation, the cleaning effect of the rail that is generated due to the sliding of the wheel on the rail.

The above and other objects and advantages are achieved, according to an aspect of the invention, by a system and a method for simulating the contact between wheel and rail for detecting the adhesion value having the features described and claimed herein. Preferential implementations of the invention are also described.

Functional and structural features of some preferred embodiments of the present invention will become apparent from the detailed description that follows, provided by way of non-limiting examples with reference to the drawings.

### BRIEF DESCRIPTION OF THE DRAWINGS

FIG. 1 illustrates two systems for simulating the contact between wheel and rail according to the prior art;

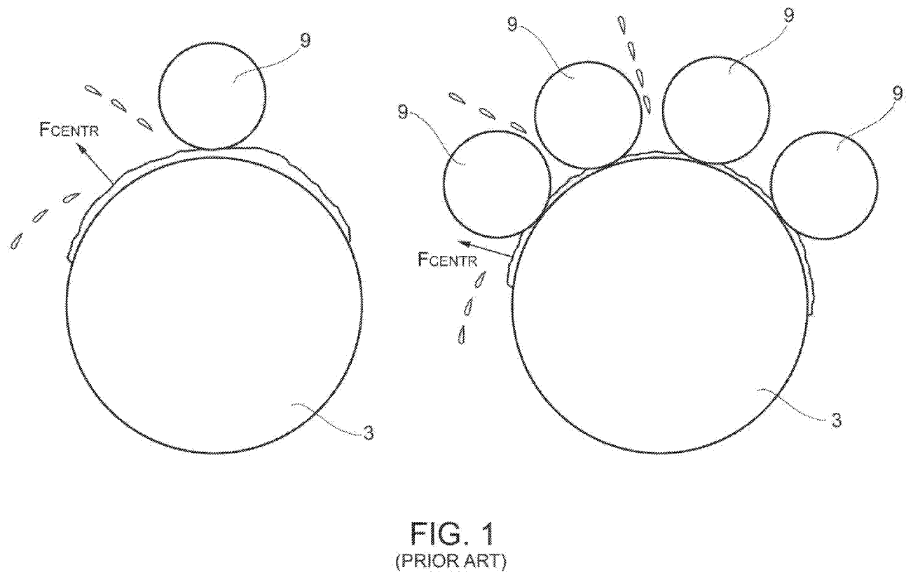

FIG. 2 illustrates a first embodiment of a system for simulating the contact between wheel and rail;

FIG. 3 illustrates a second embodiment of a system for simulating the contact between wheel and rail;

FIG. 4 illustrates a third embodiment of a system for simulating the contact between wheel and rail;

FIG. 5 illustrates a fourth embodiment of a system for simulating the contact between wheel and rail;

FIG. 6 illustrates a fifth embodiment of a system for simulating the contact between wheel and rail, wherein a rotation motor is coupled on the perimeter of the hollow cylindrical structure by means of respective toothed surfaces; and

FIG. 7 illustrates a system for simulating the contact between wheel and rail comprising a wheel slide protection system, WSP.

### DETAILED DESCRIPTION

Before explaining in detail a plurality of embodiments of the invention, it should be clarified that the invention is not limited in its application to the details of construction and to the configuration of the components provided in the following description or illustrated in the drawings. The invention may assume other embodiments and may be implemented or achieved in essentially different ways. It should also be understood that the phraseology and terminology have descriptive purposes and should not be construed as limiting. The use of “include” and “comprise” and their variations are to be understood as encompassing the elements set out to follow and their equivalents, as well as additional elements and their equivalents.

The system for simulating the contact between wheel and rail 1 according to the invention, in particular of a railway vehicle, comprises at least one hollow cylindrical structure 3, also called a roller, having a first diameter D1 and including a rail simulation surface 5 arranged integrally with an inner surface 7 of the hollow cylindrical structure 3.

The rail simulation surface 5 is preferably made of a metallic material, in particular the metallic material from which rails are usually constructed, for example, steel.

The system for simulating contact between wheel and rail 1 further comprises at least one wheel 9 having a second diameter D2, smaller than said first diameter D1, which includes a rolling surface 11 placed in contact with the rail simulation surface 5 of the hollow cylindrical structure 3.

The aforesaid arrangement allows one to avoid that the contaminant substance deposited on the roller by an injection system or manually is flung away by the roller due to centrifugal force.

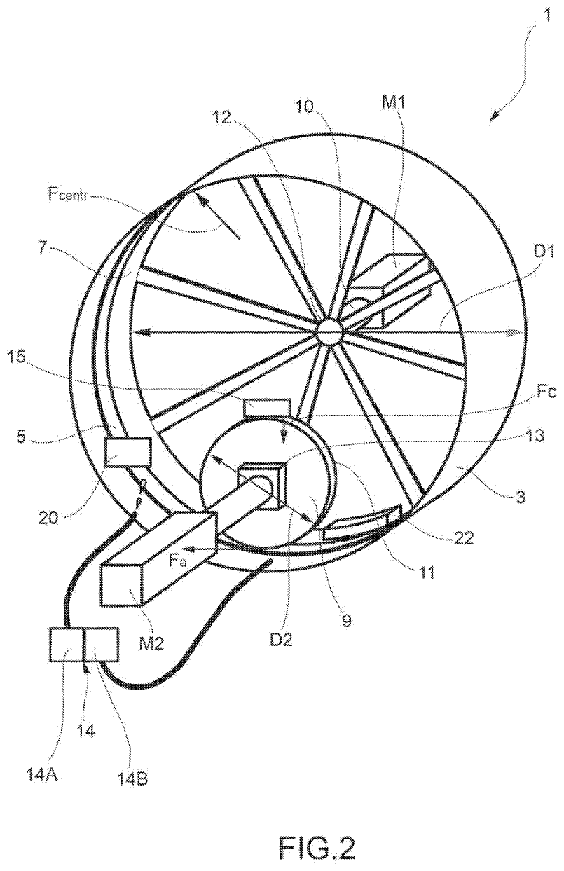

With reference to FIG. 2, the system for simulating the contact between wheel and rail 1 also includes a rotation motor M1 coupled to the cylindrical structure 3 to generate a rotation of said first cylindrical structure 3.

For example, the drive shaft 10 of the motor M1 is coupled with a respective hole 12 located at the center of the hollow cylindrical structure. For example, a plurality of rods, also called spokes, or a flat surface extending from the inner surface 7 of the hollow cylindrical structure 3 to the hole 12, may be used to hold said hole 12 in position.

Moreover, a second rotation motor M2 is associated with the wheel 9 to generate a rotation of said wheel 9 and to control the slippage thereof, i.e., the relative speed, with respect to the cylindrical structure 3.

A first sensor 13 for torque, for example a torque transducer, is placed between the motor M2 and the wheel 9 to allow the adhesion force Fa developed in the contact point between the wheel 9 and the hollow cylindrical structure 3 to be measured.

A second sensor 15 for load, for example a load cell, is located above the wheel 9 and allows the normal load force Fc acting on the rail simulation surface 5 to be measured.

The ratio between the adhesion force Fa and the normal load force Fc allows the real wheel-rail adhesion coefficient to be calculated.

The real wheel-rail adhesion coefficient is the estimated value indicative of the adhesion coefficient value that would occur in a normal condition of use of a railway vehicle.

The ratio between the adhesion force Fa and the normal load force Fc is calculated by a processor not illustrated in the figures.

Processor may mean either a control unit belonging to the system for simulating contact between wheel and rail 1 or a remote processor adapted to receive the data measured by sensors 13, 15 of the system for simulating the contact between wheel and rail 1, wherein the actual calculation of the real wheel-rail adhesion coefficient is performed.

The system for simulating the contact between wheel and rail 1 also includes at least one contaminant control system 14, adapted to recreate a variation of the friction condition between the wheel 9 and the rail simulation surface 5.

The variation of the friction condition may coincide with a decrease in the friction value if the injected contaminant substance is, for example, water, oil or leaves, while it may coincide with an increase in the friction value if the injected contaminant substance is, for example, sand.

The at least one contaminant control system 14 is placed in the proximity of each wheel 9.

The contaminant control system 14 comprises a contaminant injection system 14A to uniformly distribute the contaminant along the rail simulation surface 5.

Since the contaminant is distributed along the rail simulation surface 5, which is located on the inner surface 7 of the hollow cylindrical structure 3, the centrifugal force generated during rotation of the hollow cylindrical structure 3 facilitates checking the contaminant level. Unlike the known solutions, the contaminant, rather than being flung away from the rotating hollow cylindrical structure 3, is held along the rail simulation surface 5 by such centrifugal force.

The contaminant control device 14 may further comprise a contaminant removal system 14B, achieved, for example, with a jet of compressed air or a spatula or scraper or an aspirator, adapted to remove the contaminant from the cylindrical structure 3.

The contaminant control system 14 may comprise at least one contaminant level sensor 20 adapted to detect the level of contamination of the system for simulating the contact between wheel and rail 1. In this way, it is possible to establish whether to inject more contaminant, if the contaminant on the hollow cylindrical structure 3 is insufficient; or to stop injecting contaminant, if the contaminant on the cylindrical structure 3 is sufficient; or to remove contaminant, if its quantity on the hollow cylindrical structure 3 is excessive.

The contaminant level sensor 20 used may, for example, be at least one of either an optical sensor or a conductivity sensor.

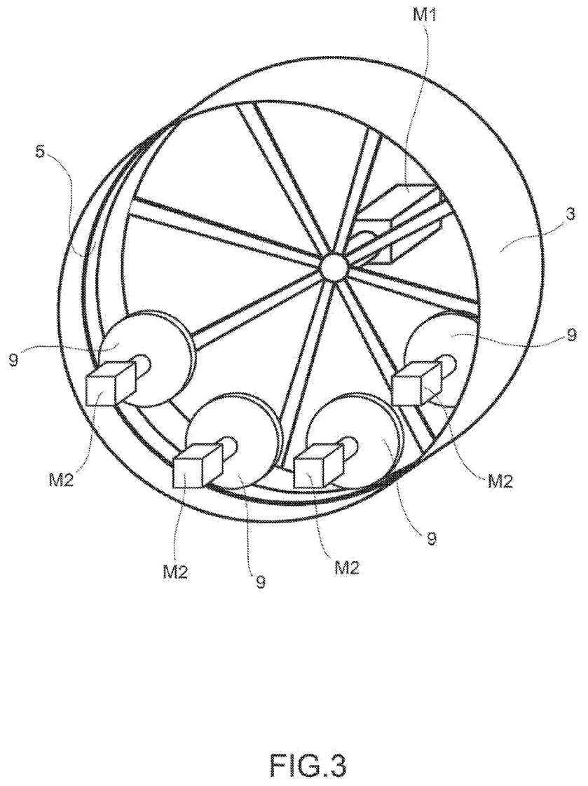

FIG. 3 illustrates a second embodiment of a system for simulating the contact between wheel and rail 1. The difference with respect to the embodiment illustrated above consists in the fact that the wheels 9 are at least two in number. In the example illustrated in this figure, there are four wheels.

The four wheels 9 are arranged longitudinally aligned with each other, in contact with the track simulation surface 5, along a plane perpendicular to the rotation axis thereof.

The fact of using more than one wheel 9, and the fact that the contaminant material is retained on the inner surface 7 of the hollow cylindrical structure 3, allows the phenomenon of rail cleaning, which occurs at the close consecutive passage of several wheels 9 slipping on a rail, to be analyzed in detail.

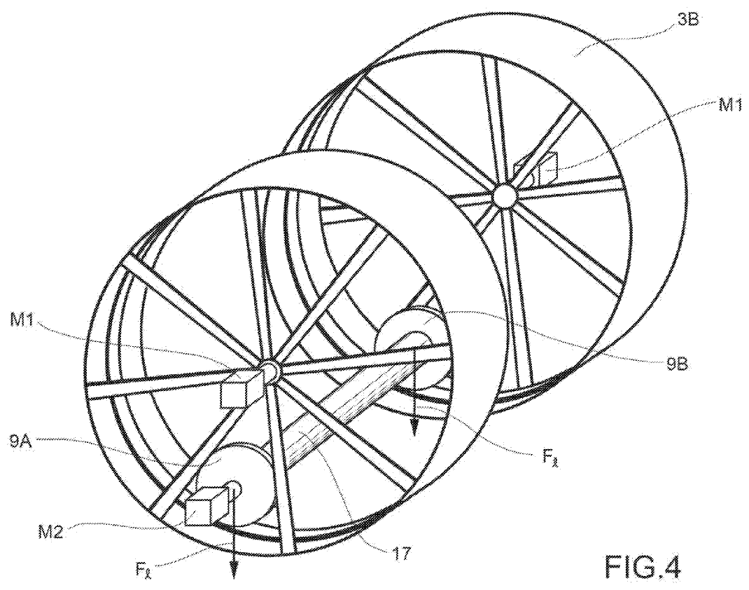

In a third embodiment illustrated in FIG. 4, the difference with respect to the embodiments illustrated above consists in the fact that there are two hollow cylindrical structures 3, which form a pair of cylindrical structures 3A, 3B, including a first hollow cylindrical structure 3A and a second hollow cylindrical structure 3B.

In particular, the second hollow cylindrical structure 3B is arranged parallel to the first hollow cylindrical structure 3A, along a common rotation axis thereof.

The wheels are divided in pairs of wheels 9A, 9B, each comprising a first wheel 9A, placed in contact with the rail simulation surface 5 of the first cylindrical structure 3A, and a second wheel 9B, placed in contact with the rail simulation surface 5 of the second cylindrical structure 3B.

The first and second wheels 9A, 9B are connected to each other by an axle 17.

The axle 17, and consequently the first and second wheels 9A, 9B, is rotated by means of the rotation motor M2.

Each hollow cylindrical structure 3A, 3B is rotated independently of the others by means of respective rotation motors M1.

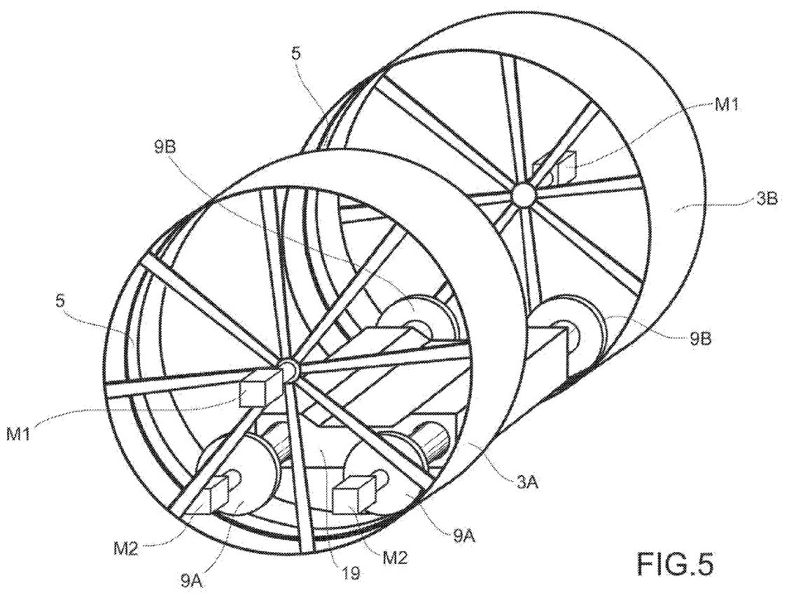

In a fourth embodiment, illustrated in FIG. 5, the pairs of wheels are at least two and are installed on a bogie 19 for a railway vehicle. The pairs of wheels are arranged longitudinally aligned with each other along a plane perpendicular to the rotation axis thereof.

To simulate the weight of a carriage acting on a rail, which occurs in a real case of travel of the railway vehicle on a rail, each wheel 9 is kept in contact with the rail simulation surface 5 through a load actuation system not illustrated in the figures, adapted to generate a force Fl to simulate the load generated by the weight of a carriage of a railway vehicle.

For example, the load actuation system may be achieved through hydraulic or pneumatic springs or actuators.

The system for simulating the contact between wheel and rail 1 may further include an electromagnetic braking system 22, known as a magnetic shoe or MTB (magnetic track brake) acting directly on the rail simulation surface 5 and positioned between the two wheels. Such system may optionally be activated to evaluate the impact on the braking force transferred to the hollow cylindrical structure 3 and to evaluate the impact thereof on the rail simulation surface 5.

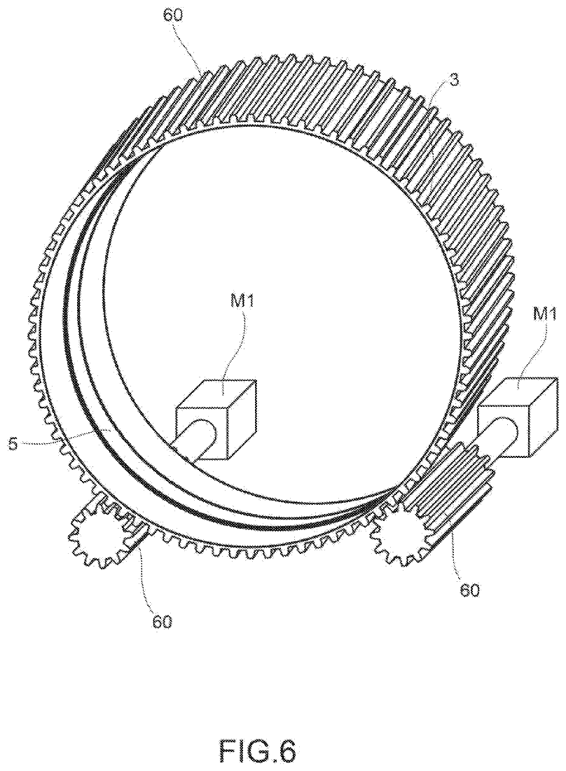

In a fifth alternative embodiment, illustrated in FIG. 6, at least one rotation motor M1, rather than being coupled with the respective hole 12 located in the center of the hollow cylindrical structure, is coupled on the perimeter of the hollow cylindrical structure 3, for example by means of respective toothed surfaces 60.

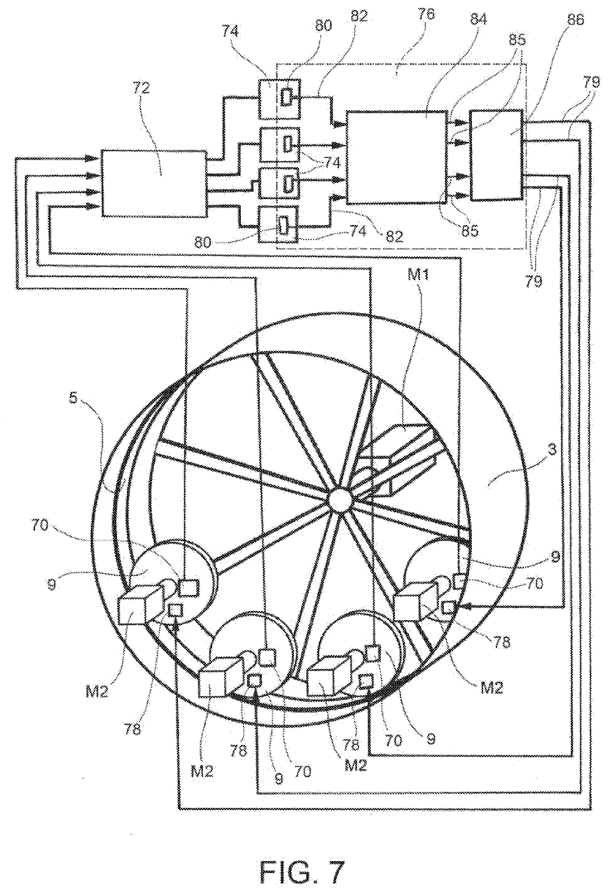

With reference to FIG. 7, a system for simulating the contact between wheel and rail comprising a wheel slide protection system 72, WSP, is illustrated.

In this case, by means of the system for simulating the contact between wheel and rail, it is also possible to simulate a real case wherein a railway vehicle has on board a wheel slide protection system 72, WSP, adapted to intervene when the wheels slip.

As illustrated in FIG. 7, the system for simulating the contact between wheel and rail 1 comprises a plurality of speed sensors 70. Each speed sensor 70 is adapted to detect an angular speed of one of said wheels 9.

The system for simulating the contact between wheel and rail 1 also comprises a slide protection system 72 of the wheels 9, WSP, adapted to determine the slide values of the wheels of which the angular speed has been detected.

The slide protection system 72 of the wheels 9, WSP, is also adapted to apply pressure to an air tank 74 adapted to simulate a brake cylinder for each wheel 9 of which the angular speed has been detected. The air tank may be a container inside of which a certain amount of air is enclosed.

The pressure value applied to the air tank 74 is generated as a function of slide values determined by the slide protection system 72, WSP. For example, the pressure value may be lower for the air tanks 74 associated with wheels that the WSP has determined to be slipping.

Moreover, the system for simulating the contact between wheel and rail 1 comprises a pressure/braking torque conversion system 76 adapted to convert the pressure value applied to the air tank 74 into respective braking torque signals 79 for each wheel, and a plurality of braking devices 78, each associated with one of said wheels whose angular speed has been detected.

Each braking device is adapted to apply to its associated wheel a braking torque corresponding to the braking torque signal 79 received from the pressure/braking torque conversion system 76.

Still referring to FIG. 7, the pressure/braking torque conversion system 76 may include a plurality of pressure transducers 80, each acting to provide an electrical pressure signal 82, the value of which corresponds to one of the pressure values applied to the air tanks 74 generated by the slide protection system 72.

The pressure/braking torque conversion system 76 may further include a pressure/force conversion module 84 adapted to convert each electrical pressure signal 82 into an electrical braking force signal 85 and a force/torque conversion module 86 adapted to convert, according to the radius of the wheels, the electrical braking force signals 85 into respective braking torque signals 79 to be supplied to the respective braking device 78.

FIG. 7 illustrates the case wherein the WSP module is used in a system for simulating the contact between wheel and rail according to the embodiment wherein the wheels 9 are arranged longitudinally aligned to each other along a plane perpendicular to the rotation axis thereof; however, such WSP system may also be used in any of the embodiments described above and shown in the figures, wherein a plurality of wheels are present.

In an alternative solution, the structure of the system for simulating the contact between wheel and rail may comprise a simplified structure and comprise at least one hollow cylindrical structure 3 having a first diameter D1 and including a rail simulation surface 5 integrally arranged with an inner surface 7 of said hollow cylindrical structure 3 and at least one wheel 9 having a second diameter D2 smaller than said first diameter D1, and including a rolling surface 11 placed in contact with said rail simulation surface 5 of the hollow cylindrical structure 3. In particular, said at least one wheel 9 may be a plurality of wheels 9 arranged longitudinally aligned with each other in contact with the rail simulation surface 5 along a plane perpendicular to the rotation axis thereof for simulating a condition of rail cleaning. Clearly, the concepts described above concerning the rotation motors M1 and M2, the first torque sensor 13, the second load sensor 15, the processor, the contaminant control system 14, the contaminant level sensor 20, the plurality of cylindrical structures 3 forming a pair of cylindrical structures 3A, 3B, the first and the second wheel 9A, 9B connected to each other by an axle 17, the pairs of wheels installed on a bogie 19 for a railway vehicle, the load actuation system, the electromagnetic braking system 22, the toothed surfaces 60, and the wheel slide protection system 72, WSP, may be applied individually or combined also with this solution.

The invention further comprises a method for simulating the contact between wheel and rail 1, in particular of a railway vehicle, comprising the steps of:
providing at least one hollow cylindrical structure 3 having a first diameter D1 and including a rail simulation surface 5 which is arranged integrally with an inner surface 7 of said hollow cylindrical structure 3; and
providing inside said first cylindrical structure 3, in contact with said rail simulation surface 5 of the cylindrical structure 3, at least one wheel 9 having a second diameter D2 smaller than said first diameter D1;
rotating said first cylindrical structure 3 by at least a first motor M1;
rotating the at least one wheel 9 by at least one rotation motor M2 associated with said at least one wheel 9;
injecting a contaminant substance on at least part of said rail simulation surface 5 through at least one contaminant control system 14;
measuring an adhesion force Fa developed at the contact point between the at least one wheel 9 and the at least one cylindrical structure 3;
checking and measuring a normal load force Fc on the rail simulation surface 5; and
calculating the real wheel-rail adhesion coefficient by the ratio between the adhesion force Fa and the normal load force Fc.

The advantage provided by the invention is therefore to provide a system and a method which allow the condition of contamination of the rail to be simulated by means of a stable contaminant layer for any type of contaminant or simulated speed.

Furthermore, it is advantageously possible to truly evaluate the influence of the contaminant with respect to the adhesion value between the wheel and the rail, and to take into consideration, during the evaluation, also the cleaning effect of the rail that is generated due to the passage of a wheel.

Several aspects and embodiments of a system and a method for simulating the contact between wheel and rail according to present the invention have been described. It is understood that each embodiment may be combined with any other embodiment. The invention, moreover, is not limited to the described embodiments, but may be varied within the scope of protection as described and claimed herein.

1. A system for simulating contact between wheel and rail, in particular of a railway vehicle, comprising:
at least one hollow cylindrical structure having a first diameter and including a rail simulation surface arranged integrally with an internal surface of said hollow cylindrical structure;
at least one wheel having a second diameter smaller than said first diameter, and including a rolling surface placed in contact with said rail simulation surface of the hollow cylindrical structure;
at least one rotation motor associated with said hollow cylindrical structure for generating a rotation of said first hollow cylindrical structure;
at least a second rotation motor associated with the at least one wheel for controlling a rotation of said at least one wheel;
at least one contaminant control system, adapted to control distribution of a contaminant on the rail simulation surface for generating a variation of a friction condition between the at least one wheel and the rail simulation surface;
at least one first sensor for torque, adapted to measure an adhesion force developed at a contact point between the at least one wheel and the at least one hollow cylindrical structure;
at least one second sensor for load, adapted to measure a normal load force on the rail simulation surface; and
a processor adapted to calculate a real wheel-rail adhesion coefficient by the ratio between the adhesion force and the normal load force.

2. The system for of claim 1, wherein said at least one wheel is a plurality of wheels; said wheels being arranged longitudinally aligned with each other in contact with the rail simulation surface along a plane perpendicular to a rotation axis thereof for simulating a condition of rail cleaning.

3. The system of claim 1, wherein:
said at least one hollow cylindrical structure is at least a pair of cylindrical structures including a first hollow cylindrical structure and a second hollow cylindrical structure; the second hollow cylindrical structure being arranged along a common rotation axis thereof;
said at least one wheel is at least a pair of wheels comprising a first wheel, placed in contact with the rail simulation surface of the first hollow cylindrical structure, and a second wheel, placed in contact with the rail simulation surface of the second hollow cylindrical structure; the first wheel and the second wheel being connected to an axle.

4. The system of claim 3, wherein the pairs of wheels are at least two and are mounted on a bogie for a railway vehicle; said pairs of wheels being arranged longitudinally aligned with each other along a plane perpendicular to the rotation axis thereof.

5. The system of claim 3, or wherein the wheels connected to the axle are controlled through a single rotation motor.

6. The system of claim 1, wherein each hollow cylindrical structure is rotated independently from the other by a rotation motor.

7. The system of claim 1, wherein the contaminant control system comprises a contaminant injection system for distributing the contaminant along the rail simulation surface, a contaminant removal system adapted to remove the contaminant from the rail simulation surface, and at least one contaminant level sensor adapted to detect the level of contamination of the system for simulating the contact between wheel and rail.

8. The system of claim 7, wherein the contaminant level sensor is at least one of either an optical sensor or a conductivity sensor.

9. The system of claim 1, wherein each wheel is held in contact with the rail simulation surface through a force adapted to simulate a load generated by the weight of a carriage of a railway vehicle.

10. The system of the preceding claims of claim 1, wherein to the at least one wheel is associated an electromagnetic braking system, acting directly on the rail simulation surface.

11. The system of claim 10, wherein the electromagnetic braking system is a magnetic shoe or magnetic track brake.

12. The system of claim 1, wherein the at least one rotation motor associated with said hollow cylindrical structure is coupled to the perimeter of said hollow cylindrical structure.

13. The system of claim 2, comprising:
a plurality of speed sensors, each speed sensor being adapted to detect an angular speed of one of said wheels;
a wheel slide protection system (WSP), adapted to determine slide values of the wheels whose angular speed has been detected and to apply pressure to an air tank adapted to simulate a brake cylinder for each wheel of which the angular speed has been detected, the pressure value applied to the air tank being generated as a function of slide values determined by the WSP;
a pressure/braking torque conversion system adapted to convert the pressure value detected in the air tank into respective braking torque signals for each wheel; and
a plurality of braking devices, each braking device being associated with one of said wheels of which the angular speed has been detected; each braking device being adapted to apply to its associated wheel a braking torque corresponding to the braking torque signal received from the pressure/braking torque conversion system.

14. The system of claim 13, wherein the pressure/braking torque conversion system includes:
a plurality of pressure transducers wherein each pressure transducer is adapted to provide an electrical pressure signal the value corresponds said electrical pressure signal corresponding to one of the pressure values applied to the air tanks by means of the WSP;
a pressure/force conversion module adapted to convert each electrical pressure signal into an electrical braking force signal; and
a force/torque conversion module adapted to convert, according to the radius of the wheels, the electrical braking force signals into respective braking torque signals to be supplied to the respective braking devices.

15. A method for simulating contact between wheel and rail, in particular of a railway vehicle, comprising the steps of:
providing at least a hollow cylindrical structure having a first diameter and including a rail simulation surface, which is arranged integrally with an inner surface of said hollow cylindrical structure;
providing inside said first hollow cylindrical structure, in contact with said rail simulation surface of the hollow cylindrical structure, at least one wheel having a second diameter smaller than said first diameter;
rotating said first hollow cylindrical structure by means of at least a first motor;
rotating the at least one wheel by at least one rotation motor associated with said at least one wheel;
injecting a contaminant substance on at least part of said rail simulation surface by means of at least one contaminant control system;
measuring an adhesion force developed at a contact point between the at least one wheel and the at least one cylindrical structure by means of at least a first sensor for torque;
checking and measuring a normal load force on the rail simulation surface by means of at least one second sensor for load; and
calculating the real wheel-rail adhesion coefficient by the ratio between the adhesion force and the normal load force.
